(19) United States
(12) Patent Application Publication
(10) Pub. No.: US 2014/0232976 A1
(43) Pub. Date: Aug. 21, 2014

(54) LIQUID CRYSTAL DISPLAY PANEL

(71) Applicant: Innolux Corporation, Miao-Li County (TW)

(72) Inventor: Chien-Hung Chen, Miao-Li County (TW)

(73) Assignee: Innolux Corporation, Miao-Li County (TW)

(21) Appl. No.: 14/133,749

(22) Filed: Dec. 19, 2013

(30) Foreign Application Priority Data
Feb. 19, 2013 (TW) 102105736

(51) Int. Cl. G02F 1/1343

(52) U.S. Cl. CPC G02F 1/1343
USPC 349/139

(57) ABSTRACT

A liquid crystal display (LCD) panel is provided. The LCD panel includes: a liquid crystal layer, a first data line, a scan line, a pixel electrode, and a first thin film transistor (TFT). The liquid crystal layer includes a high-dielectric-constant liquid crystal material, and the pixel electrode drives the liquid crystal layer. The first TFT includes a first electrode and a second electrode. The first electrode, electrically connected to the pixel electrode, has at least two first branch electrodes. The second electrode, electrically connected to the first data line, has at least one second branch electrode. A first overlapped area of the first electrode and the scan line is greater than a second overlapped area of the second electrode and the scan line, and the second branch electrode is disposed between two of the first branch electrodes.

This application claims the benefit of Taiwan application Serial No. 102105736, filed Feb. 19, 2013, the subject matter of which is incorporated herein by reference.

### BACKGROUND OF THE INVENTION

1. Field of the Invention

The disclosure relates in general to a display panel, and more particularly to a liquid crystal display panel.

2. Description of the Related Art

For the recent years, the liquid crystal displays have been widely employed in display screens for electronic products. There are various types of liquid crystal displays: such as twister nematic (TN), super twisted nematic (STN), in-plane switching (IPS), multi-domain vertical alignment (MVA), and so on. When a voltage is applied to the liquid crystal molecules, their rotation directions can be controlled to adjust the direction of polarization of light, and the amount of light passing through them is then changed so as to result in brightness between bright and dark as can be viewed.

Referring to FIG. 1, a timing diagram of a scan signal and a pixel voltage for a conventional liquid crystal display is illustrated. The drain terminal of a thin film transistor (TFT) is electrically connected to the data line, and the source terminal of the TFT is electrically connected to the pixel electrode. As long as the TFT is turned off, a scan signal V_{g} at the gate of the TFT can lead to a pixel voltage Vₚ at the source terminal of the TFT with a reduction of a kick-back voltage ΔV. This is because when the scan signal V_{g} decreases rapidly, the pixel voltage Vₚ also decreases due to a coupling phenomenon resulting from the parasitic capacitance C_{gs} between the source and gate terminals of the TFT. The kick-back voltage ΔV is proportional to

$$\frac{{C}_{gs}}{{C}_{gs} + {C}_{LC} + {C}_{st}} ,$$

where C_{LC} denotes liquid crystal capacitance, and C_{gs} denotes the parasitic capacitance between the source and gate terminals of the TFT.

In order to prevent a large kick-back voltage ΔV from leading to flicker or image sticking, the conventional display has the parasitic capacitance C_{gs} as little as possible. Following this, in the design of conventional TFTs, the area of the TFT's source terminal electrically connected to the pixel electrode is less than that of the TFT's drain terminal electrically connected to the data line. However, along with a larger size of the panel with more pixels, it is inevitable that the loading for the data lines becomes heavier, thus probably causing the problem of signal distortion.

### SUMMARY OF THE INVENTION

The disclosure is directed to a liquid crystal display panel, to provide a novel TFT design, so as to reduce the problem of data line loading and signal distortion.

According to an embodiment, a liquid crystal display (LCD) panel is provided. The LCD panel includes: a liquid crystal layer, a first data line, a scan line, a pixel electrode, and a first thin film transistor. The liquid crystal layer includes a high-dielectric-constant liquid crystal material, and the pixel electrode drives the liquid crystal layer. The first thin film transistor includes a first electrode and a second electrode. The first electrode, electrically connected to the pixel electrode, has at least two first branch electrodes. The second electrode, electrically connected to the first data line, has at least one second branch electrode. A first overlapped area of the first electrode and the scan line is greater than a second overlapped area of the second electrode and the scan line, and at least one of the second branch electrode is disposed between two of the first branch electrodes.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 (Prior Art) is a timing diagram of a scan signal and a pixel voltage for a conventional liquid crystal display.

FIG. 2 is a schematic diagram illustrating a liquid crystal display panel according to a first embodiment.

FIG. 3 is a circuit layout diagram for the liquid crystal display panel according to the first embodiment.

FIG. 4 is cross-sectional view along a line BB′.

FIG. 5 is a side view of a first electrode, a second electrode, and a scan line.

FIG. 6 shows a schematic diagram illustrating the first and second electrodes according to the first embodiment.

FIG. 7 is a schematic diagram illustrating a liquid crystal display panel according to a second embodiment.

FIG. 8 is a circuit layout diagram for the liquid crystal display panel according to the second embodiment.

FIG. 9 is a side view of a first electrode, a second electrode, a third electrode, a fourth electrode, and a scan line.

FIG. 10 shows a schematic diagram illustrating the first, the second, the third, and the fourth electrodes according to the second embodiment.

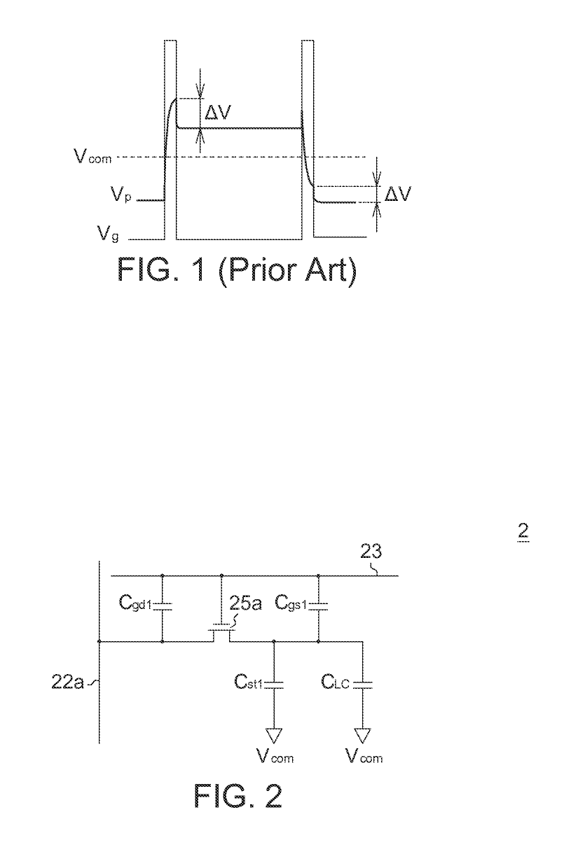

### DETAILED DESCRIPTION OF THE INVENTION

### First Embodiment

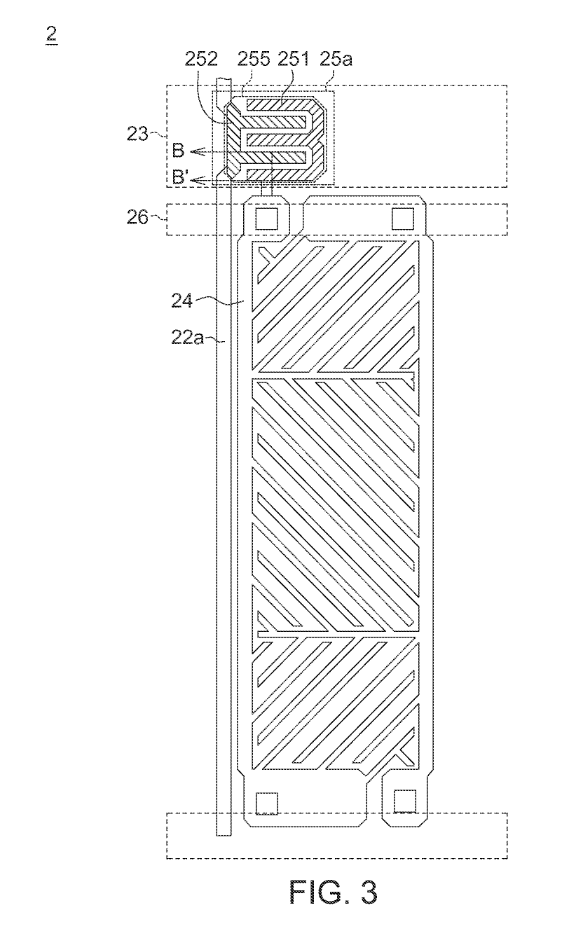

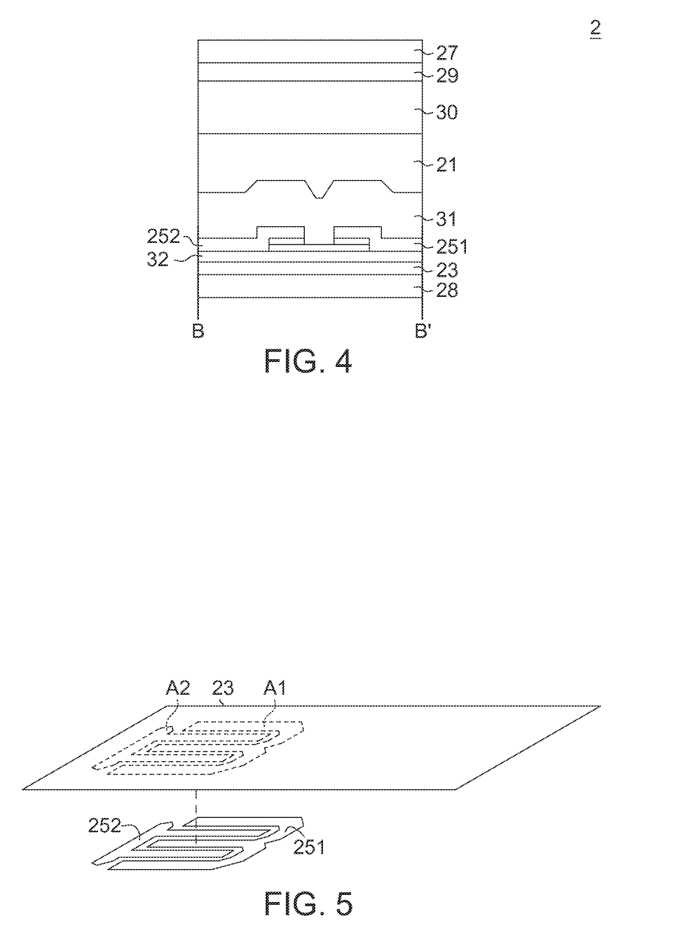

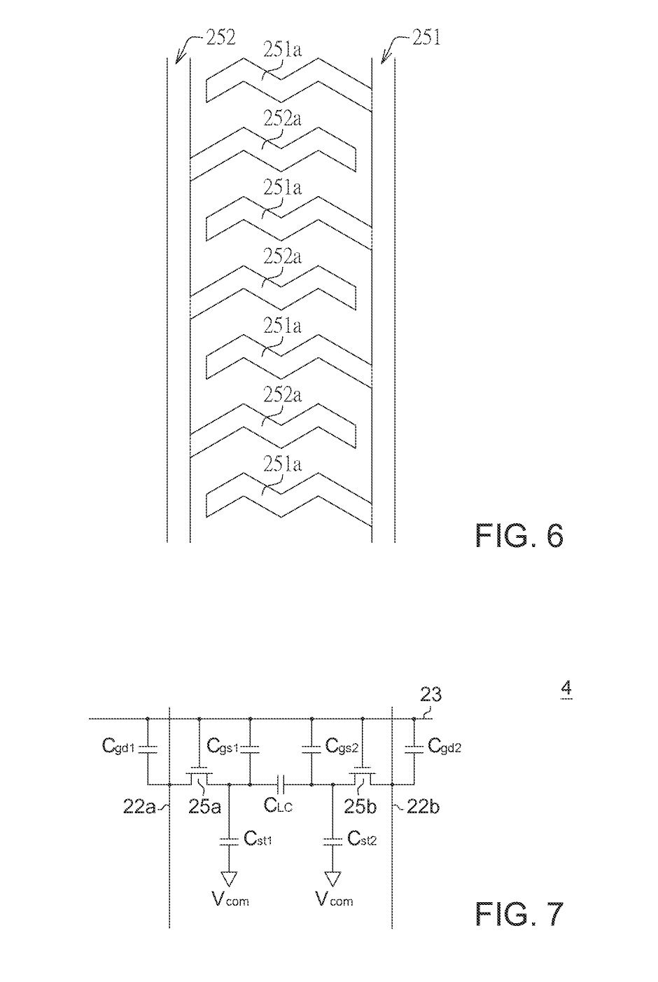

Referring to FIGS. 2, 3, 4, 5, and 6, FIG. 2 is a schematic diagram illustrating a liquid crystal display (LCD) panel 2 according to a first embodiment; FIG. 3 is a circuit layout diagram for the LCD panel according to the first embodiment; FIG. 4 is cross-sectional view along line BB′; FIG. 5 is a side view of a first electrode, a second electrode, and a scan line; and FIG. 6 shows a schematic diagram illustrating the first and second electrodes according to the first embodiment. The LCD panel 2, for example, is an in-plane switching (IPS) panel, vertical alignment (VA) panel, or IPS and VA mixing modes panel. The IPS panel changes rotation directions of the liquid crystal molecules by using a horizontal electric field, while the VA panel changes rotation directions of the liquid crystal molecules by using a vertical electric field. The IPS and VA mixing modes panel changes rotation directions of the liquid crystal molecules by using both the horizontal and vertical electric fields. The LCD panel 2 includes a liquid crystal layer 21, a first data line 22a, a scan line 23, a pixel electrode 24, a first TFT 25a, and a common electrode 26. The pixel electrode 24 is used for driving the liquid crystal layer 21, and can be in different type of shape, not limited thereto. According to different design requirement, the pixel electrode 24 can be set to a required voltage level, for example, the common voltage level provided by the common electrode 26, or a different voltage level provided by different TFT(s). The liquid crystal layer 21 includes a high-dielectric-constant liquid crystal material. The high-dielectric-constant liquid crystal material has an average dielectric constant ranging between 20 and 500, and can be blue-phase liquid crystal or other liquid crystal with a high polarity functional group, or can be added/doped with a high proportion of chiral material. An equivalent capacitance of the liquid crystal layer 21 is indicated by liquid crystal capacitance C_{LC} as shown in FIG. 2. A common voltage V_{com} is applied to the common electrode 26, and the pixel electrode 24 and the common electrode 26 form a storage capacitance Cₛₜ₁.

The first TFT 25a includes a first electrode 251, a second electrode 252, and an active layer 255, and the first electrode 251 and the second electrode 252 are formed on the active layer 255. The first TFT, for example, is an amorphous silicon TFT, low temperature poly-silicon (LTPS) TFT, or indium gallium zinc oxide (IGZO) TFT. The first TFT 25a, for example, is an asymmetrical J-type TFT with the first and the second electrodes 251 and 252. The first electrode 251 is electrically connected to the pixel electrode 24, and the second electrode 252 is electrically connected to the first data line 22a. The first electrode 251 has at least two first branch electrodes 251a. The second electrode 252 has at least one second branch electrode 252a. The first branch electrode 251a bends along the shape of the second electrode 252 to form an interdigital shape, and is partially around a portion of the second electrode 252, while the at least one second branch electrode 252a is located between the two first branch electrodes 251a. It is noted that the first branch electrode 251a and the second branch electrode 252a can be in the shape of a rectangle, L shape, semicircle shape, circular arc shape, wave shape, and other shape, without limited thereto. The number of the first branch electrodes 251a is not restricted to two, and the first electrode 251 may include two or more first branch electrode 251a. Likewise, the number of the second branch electrode 252a is not restricted to one, and the second electrode 252 may include two or more second branch electrodes 252a, and at least one second branch electrode is located between two first branch electrodes.

The LCD panel 2 further includes a first glass substrate 27, a second glass substrate 28, a black matrix (BM) 29, a color filter 30, a passivation layer 31, and a gate insulating layer 32. The scan line 23 is formed on the second glass substrate 28, and the passivation layer 31 is formed on the first electrode 251 and the second electrode 252. The gate insulating layer 32 is formed on the scan line 23. The liquid crystal layer 21 is formed between the passivation layer 31 and the color filter 30, and the black matrix 29 is formed between the color filter 30 and the first glass substrate 27. In practical applications, the embodiment is not limited thereto. In another embodiment, the LCD panel 2, to which backlight is applied by a backlight module using a color sequence method, is not necessary to employ the color filter 30. In also another embodiment, the color filter 30 can be formed on the first glass substrate 27 or the second glass substrate 28. The black matrix 29 can be formed on the first glass substrate 27 or the second glass substrate 28.

Referring to FIGS. 2, 3, 4, and 5, FIG. 5 is a side view of the first electrode, the second electrode, and the scan line. The first electrode 251 and the scan line 23 form a first capacitance C_{gs1}, and the second electrode 252 and the scan line 23 form a second capacitance C_{gd1}. A first overlapped area A1 of the first electrode 251 and the scan line 23 is greater than a second overlapped area A2 of the second electrode 252 and the scan line 23. Since the first overlapped area A1 is greater than the second overlapped area A2, the first capacitance C_{gs1} is greater than the second capacitance C_{gd1}, wherein the ratio of the first overlapped area to the second overlapped area is A1/A2, and 1<A1/A2≦4.

In the first embodiment, when the first overlapped area A1 is greater than the second overlapped area A2, the kick-back voltage ΔV will not increase accordingly. This is because the liquid crystal layer 21 with a high-dielectric-constant liquid crystal material has a larger liquid crystal capacitance C_{LC}. The larger liquid crystal capacitance C_{LC} can compensate for the increase of the first capacitance C_{gs1} so as to avoid the kick-back voltage ΔV from being increased. In addition, since the second overlapped area A2 is less than the first overlapped area A1, the second capacitance C_{gd1} is thus less than the first capacitance C_{gs1}. Therefore, using the design of TFT for the embodiment, with the TFT's channel width and length remained the same, can improve the RC delay for the first data line 22a and the scan line 23, to prevent signal distortion from occurring on the first data line 22a.

### Second Embodiment

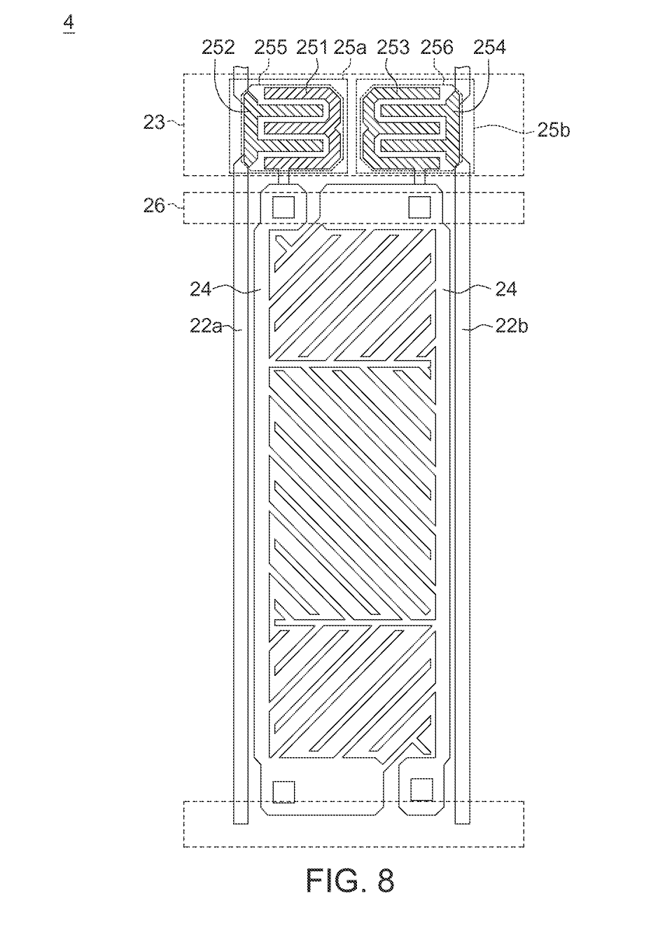

Referring to FIGS. 7, 8, and 10, FIG. 7 is a schematic diagram illustrating an LCD panel 4 according to a second embodiment; FIG. 8 is a circuit layout diagram for the LCD panel 4 according to the second embodiment; and FIG. 10 shows a schematic diagram illustrating the first, the second, the third, and the fourth electrodes according to the second embodiment. The second embodiment differs from the first embodiment in that the LCD panel 4 further includes a second data line 22b and a second TFT 25b. The second TFT 25b, for example, is an amorphous silicon TFT, an LTPS TFT, or an IGZO TFT.

The second TFT 25b includes a third electrode 253, a fourth electrode 254, and an active layer 256, and the third electrode 253 and the fourth electrode 254 are formed on the active layer 256. The third electrode 253 is electrically connected to the pixel electrode 24, and the fourth electrode 254 is electrically connected to the second data line 22b. The second TFT 25b, for example, is an asymmetrical J-type TFT with the third and the fourth electrodes 253 and 254. The third electrode 253 has at least two third branch electrodes 253a. The fourth electrode 254 has at least one fourth branch electrode 254a. The third branch electrode 253a bends along the shape of the fourth electrode 254 to form an interdigital shape, and is partially around a portion of the fourth electrode 254. It is noted that the third branch electrode 253a and the fourth branch electrode 254a can be in the shape of a rectangle, L shape, semicircle shape, circular arc shape, wave shape, and other shape, without limited thereto. The number of the third branch electrodes 253a is not restricted to two, and the third electrode 253 may include two or more third branch electrodes 253a. Likewise, the number of the fourth branch electrode 254a is not restricted to one, and the fourth electrode 254 may include two or more fourth branch electrodes 254a.

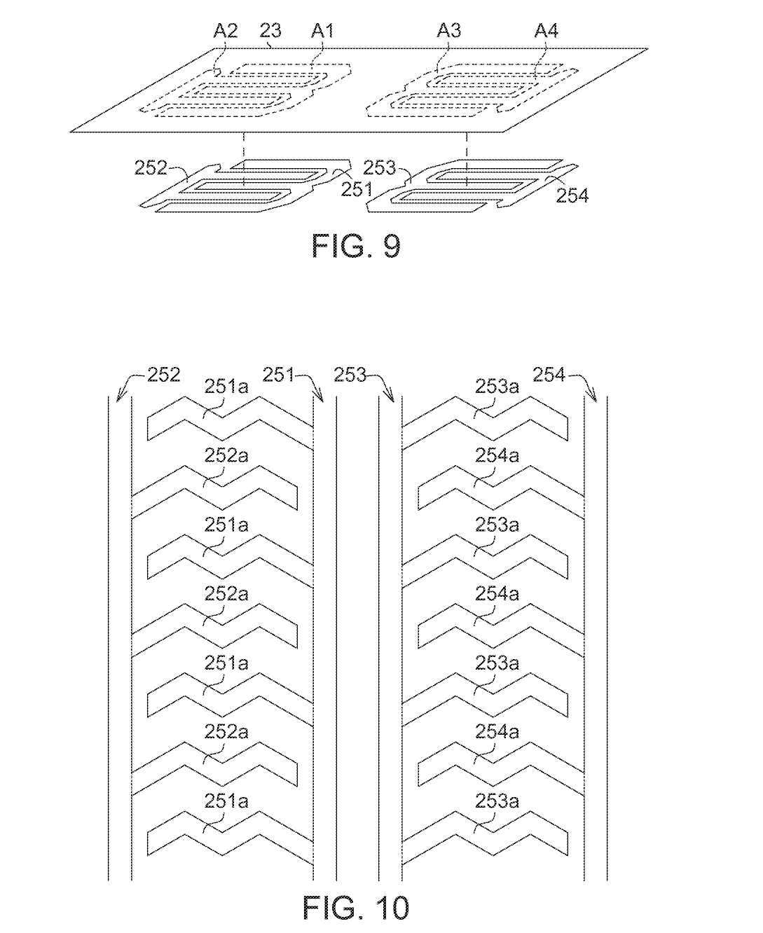

Referring to FIGS. 7, 8, and 9, 5, FIG. 9 is a side view of a first electrode, a second electrode, a third electrode, a fourth electrode, and a scan line. The third electrode 253 and the scan line 23 form a third capacitance C_{gs2}, and the fourth electrode 254 and the scan line 23 form a fourth capacitance C_{gd2}. A third overlapped area A3 of the third electrode 253 and the scan line 23 is greater than a fourth overlapped area A4 of the fourth electrode 254 and the scan line 23. Since the third overlapped area A3 is greater than the fourth overlapped area A4, the third capacitance C_{gs2} is greater than the fourth capacitance C_{gd2}, wherein the ratio of the third overlapped area to the fourth overlapped area is A3/A4, and 1<A3/A4≦4. In addition, since the fourth overlapped area A4 is less than the third overlapped area A3, the fourth capacitance C_{gd2} is less than the third capacitance C_{gs2}. Therefore, using the design of TFT for the embodiment, with the TFT's channel width and length remained the same, can improve the problem of RC delay for the third data line 22b and the scan line 23, to prevent signal distortion from occurring on the third data line 22b.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A liquid crystal display panel, comprising:
a liquid crystal layer, comprising a liquid crystal material;
a first data line;
a scan line;
a pixel electrode for driving the liquid crystal layer; and
a first thin film transistor, comprising:
a first electrode, electrically connected to the pixel electrode, having at least two first branch electrodes; and
a second electrode, electrically connected to the first data line, having at least one second branch electrode, wherein a first overlapped area of the first electrode and the scan line is greater than a second overlapped area of the second electrode and the scan line, and the second branch electrode is disposed between two of the first branch electrodes.

2. The liquid crystal display panel according to claim 1, wherein the first electrode and the scan line form a first capacitance, and the second electrode and the scan line form a second capacitance, and the first capacitance is greater than the second capacitance.

3. The liquid crystal display panel according to claim 1, wherein a ratio of the first overlapped area to the second overlapped area is greater than 1 and is smaller than or equal to 4.

4. The liquid crystal display panel according to claim 1, wherein the liquid crystal material has an average dielectric constant ranging between 20 and 500.

5. The liquid crystal display panel according to claim 1, wherein the first thin film transistor is an asymmetrical J-type thin film transistor.

6. The liquid crystal display panel according to claim 1, further comprising
a second data line; and
a second thin film transistor, comprising:
a third electrode, electrically connected to the pixel electrode, having at least two third branch electrodes; and
a fourth electrode, electrically connected to the second data line, having at least one fourth branch electrode, wherein a third overlapped area of the third electrode and the scan line is greater than a fourth overlapped area of the fourth electrode and the scan line, and the fourth branch electrode is disposed between two of the third branch electrodes.

7. The liquid crystal display panel according to claim 6, wherein the third electrode and the scan line form a third capacitance, and the fourth electrode and the scan line form a fourth capacitance, and the third capacitance is greater than the fourth capacitance.

8. The liquid crystal display panel according to claim 6, wherein a ratio of the third overlapped area to the fourth overlapped area is greater than 1 and is smaller than or equal to 4.

9. The liquid crystal display panel according to claim 6, wherein the liquid crystal material has an average dielectric constant ranging between 20 and 500.

10. The liquid crystal display panel according to claim 6, wherein the second thin film transistor is an asymmetrical J-type thin film transistor.
